(19) United States
(12) Patent Application Publication
(10) Pub. No.: US 2023/0417983 A1
(43) Pub. Date: Dec. 28, 2023

(54) CO-ALKALI DOPED OPTICAL FIBERS

(71) Applicant: CORNING INCORPORATED, CORNING, NY (US)

(72) Inventors: Sushmit Sunil Kumar Goyal, Painted Post, NY (US); Rostislav Radiyevich Khrapko, Corning, NY (US); Craig Daniel Nie, Horseheads, NY (US); Benjamin Pelham Schrock, Wilmington, NC (US); Samuel David Stewart, Wilmington, NC (US); Pushkar Tandon, Painted Post, NY (US)

(21) Appl. No.: 18/211,696

(22) Filed: Jun. 20, 2023

Related U.S. Application Data
(60) Provisional application No. 63/355,838, filed on Jun. 27, 2022.

(51) Int. Cl. G02B 6/02

(52) U.S. Cl. CPC G02B 6/02395; G02B 6/02014; G02B 6/02019

(57) ABSTRACT

An optical fiber comprising a core region doped with a first alkali dopant and a second alkali dopant. The first alkali dopant has a first average core concentration of C1 and a first diffusivity D1. The second alkali dopant has a second average core concentration of C2 and a second diffusivity D2. An outer cladding region surrounds the core region. The diffusivities D1, D2 of the first and second alkali dopants satisfy the relation D1>D2. The average core concentrations C1, C2 of the first and second alkali dopants satisfy the relation 0.1≤C2/C1≤1.

### BACKGROUND

This application claims the benefit of priority under 35 U.S.C § 120 of U.S. Provisional Application Ser. No. 63/355,838 filed on Jun. 27, 2022, the content of which is relied upon and incorporated herein by reference in its entirety.

### FIELD

The present disclosure generally relates to optical fibers having a core containing a first alkali dopant and a second alkali dopant.

### BACKGROUND

Transmission systems have traditionally included electrical power constraints that are expensive and problematic. For example, long distance intercontinental and other submarine transmission systems typically have significant attenuation. Fiber optic systems generally exhibit a lower attenuation than traditional electrical signal communications and, as a result, have been critical in improving certain aspects of transmission. As such, there is a continuing technological advancement and widespread adoption in fiber optic technology for different types of transmission.

While fiber optic systems have greatly advanced transmission over conventional means, silica optical fibers within the system still exhibit attenuation of optical signals over long distances due to Rayleigh scattering of the optical signal. Lower attenuation has been achieved by introducing an alkali dopant into the core of optical fibers. An alkali dopant reduces the fictive temperature of the core and, consequently, reduces Rayleigh scattering. Alkali dopants include sodium oxide, potassium oxide, rubidium oxide, or cesium oxide. While lowering attenuation, alkali dopants have high diffusivity and tend to diffuse away from the core at the temperatures required to draw optical fibers from preforms. It is consequently difficult to control and maintain an optimal concentration profile of an alkali dopant in the core and the capacity of an alkali dopant to reduce attenuation is accordingly compromised. The overall concentration profile of an alkali dopant in the core influences not only Rayleigh scattering, but also the contributions of small-angle scattering, absorption and defects to fiber attenuation. While optical amplifiers have improved long distance transmission by compensating for attenuation, they are costly and can negatively impact system reliability.

Accordingly, there is a continuing need to further reduce optical fiber attenuation.

### SUMMARY

The present disclosure provides an optical fiber with a core containing a first alkali dopant and a second alkali dopant with concentrations and diffusion profiles configured to improve signal attenuation.

According to one aspect, an optical fiber is provided. The optical fiber comprises a core region comprising silica glass doped with a first alkali dopant and a second alkali dopant. The first alkali dopant has a first average core concentration C1 and a first diffusivity D1. The second alkali dopant has a second average core concentration C2 and a second diffusivity D2, the second diffusivity D2 is less than the first diffusivity D1. A cladding region surrounds the core region. The average core concentrations C1, C2 of the first and second alkali dopants satisfy a relation 0.10≤C2/C1≤1.00.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is an end view of an optical fiber with a core region containing a first alkali dopant and a second alkali dopant in accordance with one aspect of the disclosure;

FIG. 2 is a refractive index profile of a first exemplary embodiment of an optical fiber with a core region containing the first alkali dopant and the second alkali dopant;

FIG. 3 is a refractive index profile of a second exemplary embodiment of an optical fiber with a core region containing the first alkali dopant and the second alkali dopant;

FIG. 4 is a refractive index profile of a third exemplary embodiment of an optical fiber with a core region containing the first alkali dopant and the second alkali dopant;

FIG. 5 is a graphical representation of an optical fiber wherein the first alkali dopant is potassium oxide and the second alkali dopant is rubidium oxide illustrating a dopant concentration in parts per million (ppm) as a function of a radial position in the optical fiber in accordance with one aspect of the disclosure;

FIG. 6 is a graphical representation of a preform cane of an optical fiber illustrating a dopant concentration as a function of a radial position in the preform cane before a drawing process in accordance with one aspect of the disclosure;

FIG. 7 is a graphical representation of a prior art optical fiber with a single alkali dopant of potassium illustrating a relationship between the power density of an optical signal in the optical fiber and a radial concentration in ppm of the single alkali dopant; and

FIG. 8 is a graphical representation that compares an optical fiber in accordance with one aspect of the disclosure with prior art optical fibers illustrating a comparative reduction in attenuation achieved by incorporating the first and second alkali dopants rather than a single alkali dopant.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

The present disclosure generally relates to optical fibers having a first alkali dopant and a second alkali dopant. The following terms as used herein have the following meanings:

“Optical fiber” refers to a waveguide having a glass portion optionally surrounded by a coating. The glass portion includes a core and a cladding. The cladding surrounds and is directly adjacent to the core and includes two or more concentric regions that differ in relative refractive index. The relative refractive index of the core is greater than the relative refractive index of the cladding. The glass portion of the optical fiber is referred to herein as a “glass fiber”.

“Radial position,” “radius,” or the radial coordinate “r” refers to radial position in a radial direction relative to the centerline (r=0) of the glass fiber.

“Axial direction” refers to a direction parallel to the centerline of the glass fiber.

“Radial direction” refers to a direction perpendicular to the axial direction.

“Cross-section” refers to a cross-section perpendicular to the axial direction.

“Refractive index” refers to the refractive index at a wavelength of 1550 nm.

“Concentration” refers to concentration on the basis of weight and is expressed in terms of ppm or wt %. The term “ppm” refers to parts per million by weight. A measurement in weight percent (wt %) can be converted to ppm by multiplying by a factor of 10,000.

“Effective area” of an optical fiber is defined in Eq. (1) as:

$${A}_{eff} = \frac{2 {π [ {\int }_{0}^{∞} {( f ( r ) )}^{2} rdr ]}^{2}}{{\int }_{0}^{∞} {( f ( r ) )}^{4} rdr} \qquad ( 1 )$$

where f(r) is the transverse component of the electric field of the guided optical signal and r is radial position in the fiber. “Effective area” or “A_{eff}” depends on the wavelength of the optical signal and is understood herein to refer to a wavelength of 1550 nm, unless otherwise specified.

The “mode field diameter” or “MFD” of an optical fiber is defined in Eq. (2) as:

$$MFD = 2 w {w}^{2} = 2 \frac{{\int }_{0}^{∞} {( f ( r ) )}^{2} rdr}{{\int }_{0}^{∞} {( \frac{df ( r )}{dr} )}^{2} rdr} \qquad ( 2 )$$

where f(r) is the transverse component of the electric field distribution of the guided optical signal and r is radial position in the fiber. “Mode field diameter” or “MFD” depends on the wavelength of the optical signal and is reported herein for a wavelength of 1550 nm. Unless otherwise specified, mode field diameter refers to the LP₀₁ mode at the specified wavelength.

“Relative refractive index,” as used herein, is defined for any radial position r in Eq. (3) as:

$$Δ \% = 100 \frac{( {n}^{2} - {n}_{ref}^{2} )}{2 {n}^{2}} \qquad ( 3 )$$

where n is the refractive index at the radial position r in the glass fiber, unless otherwise specified and n_{ref} is the refractive index of pure silica glass, unless otherwise specified. As used herein, the relative refractive index is represented by Δ (or “delta”) or Δ % (or “delta %”) and its values are given in units of “%,” unless otherwise specified.

The term “refractive index profile” is the relation between relative refractive index (Δ %) and radius. It is understood that the value of the relative refractive index may vary with radial position within the core region and/or any of the cladding regions. When relative refractive index varies with radial position in a particular region of the fiber (e.g. core region and/or any of the cladding regions), it is expressed in terms of its actual or approximate functional dependence, or its value at a particular position within the region, or in terms of an average value applicable to the region as a whole. Unless otherwise specified, if the relative refractive index of a region (e.g. core region and/or any of the cladding regions) is expressed as a single value or as a parameter (e.g. Δ or Δ % or %) applicable to the region as a whole, it is understood that the relative refractive index in the region is constant, or approximately constant, and corresponds to the single value, or that the single value or parameter represents an average value of a non-constant relative refractive index dependence with radial position in the region.

The average relative refractive index (Δₐᵥₑ) of a region of the fiber is defined in Eq. (4) as:

$${Δ}_{ave} = {\int }_{{r}_{inner}}^{{r}_{o u t e r}} \frac{Δ ( r ) dr}{( {r}_{o u t e r} - {r}_{inner} )} \qquad ( 4 )$$

where rᵢₙₙₑᵣ is the inner radius of the region, rₒᵤₜₑᵣ is the outer radius of the region, and Δ(r) is the relative refractive index of the region.

The term “α-profile” or “alpha profile” refers to a relative refractive index profile Δ(r) that has the functional form defined in Eq. (5) as:

$$Δ ( r ) = Δ ( {r}_{0} ) [ 1 - {[ \frac{\vert r - {r}_{0} \vert}{( {r}_{z} - {r}_{0} )} ]}^{α} ] \qquad ( 5 )$$

where rₒ is the radial position at which Δ(r) is maximum, r_{z}>r₀ is the radial position at which Δ(r) decreases to its minimum value, and r is in the range rᵢ≤r≤r_{f}, where rᵢ is the initial radial position of the α-profile, r_{f} is the final radial position of the α-profile, and α is a real number.

Core region refers to that portion of the optical fiber which has a raised index of refraction relative to the cladding region, so that the transmitted optical power propagates predominately through the core region. The core region may be comprised of one or more segments. An individual core segment may have a refractive index greater than pure silica, equal to pure silica, or less than pure silica.

Cladding region refers to that portion of the optical fiber (or optical fiber preform) surrounding and directly adjacent to the core region, which has a lower index of refraction relative to the core region. The cladding region and the core region differ in composition and define a core-clad interface in the optical fiber (or optical fiber preform). In the optical fiber preform or an optical fiber drawn from the preform, this core-clad interface may have cross-sectional variations in the axial direction as a result of normal manufacturing variation during preform production and/or the process of drawing an optical fiber. The core region ends, and the cladding region begins, at a radius r_{core}, and the cladding region ends at a radius r_{oc}, where r_{oc} corresponds to the outer radius of the glass fiber and r_{oc}>r_{core}.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error, production limitations, and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The term “formed from” can mean one or more of comprises, consists essentially of, or consists of. For example, a component that is formed from a particular material can comprise the particular material, consist essentially of the particular material, or consist of the particular material.

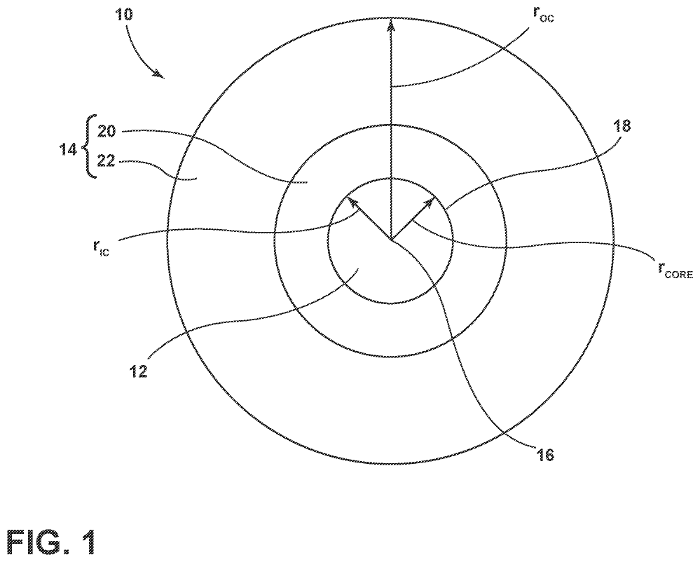

In some preferred embodiments, the core region consists of a single core segment, namely a central core segment, and a cladding region surrounding and directly adjacent the central core segment, as represented by FIG. 1, wherein the central core segment has a positive relative refractive index Δ₁(r) relative to the cladding region. In other preferred embodiments, the core region comprises multiple core segments, such as a central core segment and a first annular core segment surrounding and directly adjacent the central core segment, and a cladding region surrounding and directly adjacent the first annular core segment, wherein the central core segment has a relative refractive index Δ₁% (r) that is positive relative to the cladding region.

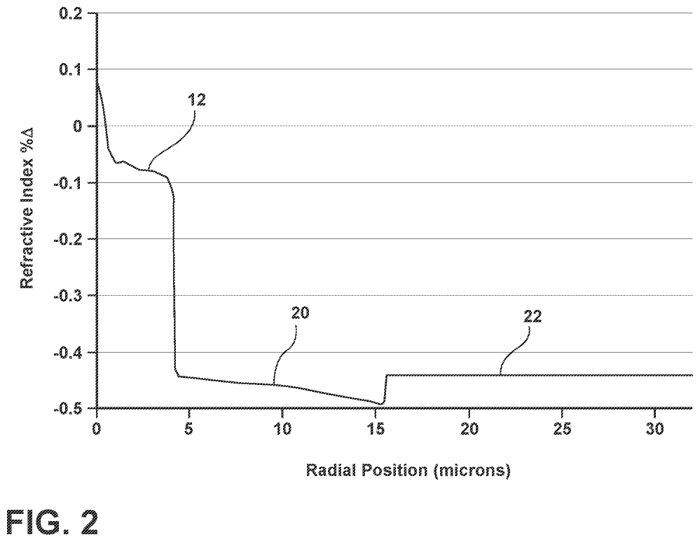

With reference to FIG. 1, a low loss optical fiber is generally designated by reference numeral 10. The optical fiber 10 disclosed herein comprises a core region 12 and a cladding region 14 surrounding and directly adjacent the core region 12. The core region 12 may be substantially cylindrical in shape and the cladding region 14 may be substantially annular in shape. The core region 12 may be formed of a doped silica glass and the cladding region 14 may also be formed of silica glass. The silica glass in the cladding region 14 may also be doped, for example, with fluorine or chlorine. In some embodiments, the core region 12 contains essentially no germania, for example, no germania. In some embodiments, the core region 12 is silica glass doped with only two or more alkali dopants, or with only two alkali dopants. The core region 12 may extend radially between a center 16 (also referred to as “centerline” of the optical fiber 10 when extended in an axial direction along the length of the optical fiber and corresponding to radial position r=0) and an outer radius reo. The core region 12 also extends in an axial direction along a length of the optical fiber 10. The core region 12 may have a relative refractive index Δ_{core}. The cladding region 14 may extend radially between an inner radius r_{1C} (corresponding to outer radius r_{core} of the core region) and an outer radius r_{oc} along the length of the optical fiber 10. The cladding region 14 may have a relative refractive index Δ_{OC} that is less than the relative refractive index Δ_{core} of the core region 12. Together, the outer radius r_{core} and the inner radius r_{1C} define a core-clad interface 18. In some embodiments, the cladding region 14 comprises an inner cladding region 20 and an outer cladding region 22, wherein the inner cladding region 20 forms a trench that has a relative refractive index that is lower than the relative refractive index of the outer cladding region (FIGS. 2-4). In some embodiments, the trench is formed directly adjacent to the core region 12 (as shown in the embodiment of FIG. 1). In other embodiments, the trench is offset from the core region 12 by an offset cladding layer directly adjacent to the core region 12, where the offset cladding region has a higher relative refractive index than the trench. The cladding region 14 as used herein is the region that is directly adjacent to the core region 12. As described below, it should be appreciated that, in some embodiments, the first alkali dopant and the second alkali dopant may be present in the cladding region 14, particularly in regions near a core-clad interface 18 (i.e. in higher concentrations near the inner radius r_{1C} than the outer radius r_{oc}).

The core region 12 contains a plurality of at least two alkali dopants, for example, a first alkali dopant and a second alkali dopant. The first alkali dopant has a first average concentration C1 in the core region (referred to herein as the “first average core concentration C1”) and a first diffusivity D1 in the core region. The second alkali dopant has a second average concentration C2 in the core region (referred to herein as the “second average core concentration C2”) and a second diffusivity D2 in the core region. In some embodiments, the second diffusivity D2 of the second alkali dopant is lower than the first diffusivity D1 of the first alkali dopant. Under the heating conditions associated with fiber draw production from a corresponding optical fiber preform, the lower diffusivity D2 results in the second alkali dopant being concentrated to a greater degree in central regions of the core region 12 (e.g. around the center 16 and spaced from the outer radius Eco) relative to the first alkali dopant. That is, the ratio C2/C1 is higher in the optical fiber than in the optical fiber preform from which the optical fiber is drawn. The relative values of the diffusivities D1 and D2 control the radial distribution of the alkali dopants and since the viscosity of silica glass depends on the concentration of alkali dopants, the concentration and radial distribution of alkali dopants can be controlled through processing conditions (e.g. temperature of fiber draw) to control the viscosity of the core region. In particular, controlling the viscosity of the core region 12 to achieve close matching of viscosity of the core region 12 with the cladding region 14 at the core-clad interface 18 may promote a reduction in the small-angle scattering contribution to fiber attenuation. The use of the two alkali dopants also allows for higher overall net concentration of alkali dopants to be incorporated in the core region 12, which may act to prevent or minimize devitrification. The average core concentration C1 of the first alkali dopant is defined in Eq. (6) and the average core concentration C2 of the second alkali dopant is defined in Eq. (7):

$$C 1 = \frac{2}{{( {MFD}_{1550} / 2 )}^{2}} {\int }_{0}^{{MFD}_{1550} / 2} C 1 ( r ) rdr \qquad ( 6 )$$

$$C 2 = \frac{2}{{( {MFD}_{1550} / 2 )}^{2}} {\int }_{0}^{{MFD}_{1550} / 2} C 2 ( r ) rdr \qquad ( 7 )$$

where MFD is the mode field diameter of the fiber at a wavelength of 1550 nm, C1(r) is the concentration of the first alkali dopant as a function of radial coordinate (referred to herein as “the radial concentration profile of the first alkali dopant”), and C2(r) is the concentration of the second alkali dopant as a function of radial coordinate (referred to herein as “the radial concentration profile of the second alkali dopant”). The diffusivity of different alkali in silica for temperatures above the softening point and temperatures in the glass transition region of the core glass have been reported by various authors, including Rothman et al., J. American Ceramic Soc., 65 (11), 578-582 (1982) and Sakuma et al., U.S. Pat. No. 10,031,282 (2018), which are incorporated herein in their entireties. These studies show that the diffusivity of different alkali in the glass follow the following relation: D_{Na}>D_{K}>D_{Rb}>D_{Cs} over the entire temperature ranges of interest herein.

In some embodiments, the first alkali dopant is potassium oxide (K₂O) and the second alkali dopant is rubidium oxide (Rb₂O). In other embodiments, the first alkali dopant is sodium oxide (Na₂O) and the second alkali dopant is potassium oxide (K₂O). However, it should be appreciated that other combinations of the first alkali dopant and the second alkali dopant can be used. For example, the first alkali dopant and/or the second alkali dopant may include various alkali metal oxides, such as K₂O, Na₂O, LiO₂, Rb₂O, Cs₂O, and/or the like, wherein the first alkali dopant has a higher diffusivity than the second alkali dopant. The diffusivity may generally coincide with a molecular weight, wherein a lower molecular weight corresponds to a higher diffusivity. Therefore, in some embodiments, the first alkali dopant has a first molecular weight and the second alkali dopant has a second molecular weight that is greater than the first molecular weight.

The average core concentration C1 of the first alkali dopant is greater than the average core concentration C2 of the second alkali dopant. A ratio of the average core concentration C2 of the second alkali dopant to the average core concentration C1 of the first alkali dopant may be between about 0.10 and 1.00, for example, about 0.10, about 0.10 or greater, about 0.20 or less, about 0.20 or greater, between about 0.1 and 0.99, between about 0.15 and 0.90, between about 0.20 and about 0.90, between about 0.20 and about 0.80, between about 0.20 and about 0.70, between about 0.40 and about 0.70, about 0.30 or less, about 0.30 or greater, between about 0.30 and about 0.80, between about 0.30 and about 0.70, about 0.40 or less, about 0.40 or greater, about 0.50 or less, about 0.50 or greater, about 0.60 or less, about 0.60 or greater, about 0.70 or less, about 0.70 or greater, about 0.80 or less, about 0.80 or greater, about 0.90 or less, about 0.90 or greater, or about less than 1.00. In some embodiments, a sum C1+C2 of the average core concentrations of the first and second alkali dopants is between 10 ppm and 500 ppm. In some embodiments, the average core concentration C1 of the first alkali dopant is between 10 ppm and 400 ppm, or between 30 ppm and 300 ppm, or between 50 ppm and 200 ppm. In some embodiments, the average core concentration C2 of the second alkali dopant is between 5 ppm and 400 ppm, or between 30 ppm and 300 ppm, or between 50 ppm and 200 ppm.

In some embodiments, the effective area of the optical fiber 10 at a wavelength of 1550 nm is between 60 μm² and 100 μm². In other embodiments, the effective area of the optical fiber 10 at a wavelength of 1550 nm is between 100 μm² and 160 μm². In some embodiments, the optical fiber 10 includes a core region 12 doped with a first alkali dopant, potassium oxide, and a second alkali dopant, rubidium oxide, at an average core concentration ratio C2/C1 of about 0.6 Rb₂O/K₂O, where the optical fiber 10 exhibits a transmission loss (i.e., an attenuation loss) of less than 0.17 dB/km at a wavelength of 1550 nm, less than 0.16 dB/km at a wavelength of 1550 nm, or less than 0.15 dB/km at a wavelength of 1550 nm. In some embodiments, the optical fiber 10 exhibits a small angle scattering loss of less than 0.004 dB/km at a wavelength of 1550 nm, for example, less than 0.003 dB/km at a wavelength of 1550 nm. In some embodiments, the optical fiber 10 exhibits a Rayleigh scattering loss of less than 0.14 dB/km at a wavelength of 1550 nm, or less than 0.13 dB/km at a wavelength of 1550 nm, for example, less than 0.126 dB/km at a wavelength of 1550 nm.

The attenuation of an optical fiber 10 (without bending) consists of scattering loss and absorption loss (both intrinsic and extrinsic). The scattering loss is a combination of Rayleigh, Raman, and Brillouin scattering, as well as small angle scattering (SAS). For purposes of the present disclosure, the Rayleigh scattering loss dominates over the Raman and Brillouin scattering losses so that the scattering loss can be approximated as a sum of the Rayleigh scattering loss and the small angle scattering loss (SAS). The contribution of the extrinsic absorption loss to the total attenuation can be calculated by determining the total attenuation of the optical fiber 10, the scattering loss (approximated as the sum of the Rayleigh scattering loss and the small angle scattering loss (SAS)), and the intrinsic absorption loss of the glass material at the wavelength of interest (1550 nm), as shown in Eq. (8) below:

Extrinsic Absorption Contribution=(Total Attenuation)−(Rayleigh Scattering Loss)−(SAS)−(Intrinsic Absorption) (8)

The total attenuation in Eq. (8) is measured using the Optical Time Domain Reflectometry (OTDR) method at a wavelength of 1550 nm, as is well known in the art.

The Rayleigh scattering loss is first calculated over the visible wavelength range (400 nm-1000 nm). Based upon this calculation, the Rayleigh scattering loss for the infrared wavelength range (1550 nm) is then extrapolated, as discussed further below.

The Rayleigh scattering loss α (dB/km) is calculated over the visible wavelength range (400 nm-1000 nm, equivalent to 0.400 micron-1.000 micron) using Eq. (9):

α=R/λ⁴ (9)

where R is the Rayleigh coefficient (dB/km/μm⁴), which is measured using the spectral cutback method, as is known in the art, and plotting attenuation vs. the inverse of wavelength to the fourth power over the visible range (400 nm to 1000 nm). The slope of this plot is equal to the Rayleigh coefficient (R).

The Rayleigh coefficient R in Eq. (9) is over the visible wavelength range and, therefore, represents the Rayleigh coefficient R of the core region 12 of the optical fiber 10 since the light is essentially confined to the core region 12 over the visible wavelength range. However, at 1550 nm, the mode field diameter of the optical fiber 10 is larger than in the visible wavelength range and, as a result, a finite amount of light (evanescent tail) of an optical signal with a wavelength of 1550 nm propagating in the core region 12 extends into the cladding region 14. Therefore, the Rayleigh scattering loss a calculated in Eq. (9) assumes that the optical signal propagates only within the core region 12 of the optical fiber 10 and does not take into account the portion of the optical signal that propagates within the cladding region 14. Eq. (10) below determines the Rayleigh scattering loss of an optical fiber 10 while accounting for both the propagation of light within the core region 12 and cladding region 14. Eq. (10) is used to determine the Rayleigh scattering loss at 1550 nm:

$${α}^{′} = \frac{{\int }_{0}^{∞} α ( r ) {( f ( r ) )}^{2} rdr}{{\int }_{0}^{∞} {( f ( r ) )}^{2} rdr} \qquad ( 10 )$$

where α′ is the Rayleigh scattering loss at a wavelength of 1550 nm (dB/km/μm⁴), α(r) is the adjusted Rayleigh scatting loss (dB/km), as discussed further below, f(r) is the transverse component of the electric field of the guided optical signal and r is the radial position in the optical fiber 10. For example, when the cladding region 14 is comprised of silica doped with fluorine such that the concentration of fluorine is within the range of 0.75 wt. % to 1.2 wt. %, the Rayleigh coefficient of the cladding region 14 is about 0.95 dB/km/μm⁴ and α(r) is equal to 0.95 dB/km/μm⁴ in accordance with Eq. (10). It should be appreciated that when r is greater than the outer radius r_{core} of the core region 12, other values of α(r) can be used, based upon, for example, the concentration of fluorine in the outer cladding region 14 of the optical fiber. As discussed above, the Rayleigh Scattering Loss at 1550 nm (α′) is the total Rayleigh Scattering Loss and is the combination of Rayleigh, Raman, and Brillouin scattering.

The SAS in Eq. (8) is a contribution to the total scattering in the optical fiber 10 and provides microstructural information over a very small angular range of the fiber axis. The SAS is measured by placing the optical fiber 10 to be measured in two separate angular scattering measurement setups. SAS is the deviation of the scattering signal from the Rayleigh scattering signal that can be taken to scale using Eq. (11):

˜(1+(cos(θ))²) (11)

Further details regarding obtaining and characterizing SAS can be found in Mazumder et al., J. Applied Physics, 96 (8), 4042-4049 (2004), which is hereby incorporated by reference in its entirety.

The radial concentration profiles C1(r) and C2(r) of the first and second alkali dopants may vary between the center 16 of the core region 12 and the outer radius r_{core}. In some embodiments, the radial concentration profile C1(r) of the first alkali dopant and/or the radial concentration profile C2(r) of the second alkali dopant may decrease or increase in the radial direction over at least a portion of the distance between center 16 and outer radius r_{core}. In some embodiments, the radial concentration profile C1(r) of the first alkali dopant may decrease or increase at a first rate R1 and the radial concentration profile C2(r) of the second alkali dopant may decrease or increase at a second rate R2 that is different than the first rate R1 at a particular radial position between the center 16 of the core region 12 and the outer radius r_{core}. It should be appreciated that the radial concentration profiles C1(r) and C2(r) of the first alkali dopant and the second alkali dopant may vary slightly at different cross-sections in the axial direction over the length of the core region 12 along the optical fiber 10 and may also vary slightly at different azimuthal positions at a particular radial position as a result of normal manufacturing variability during production.

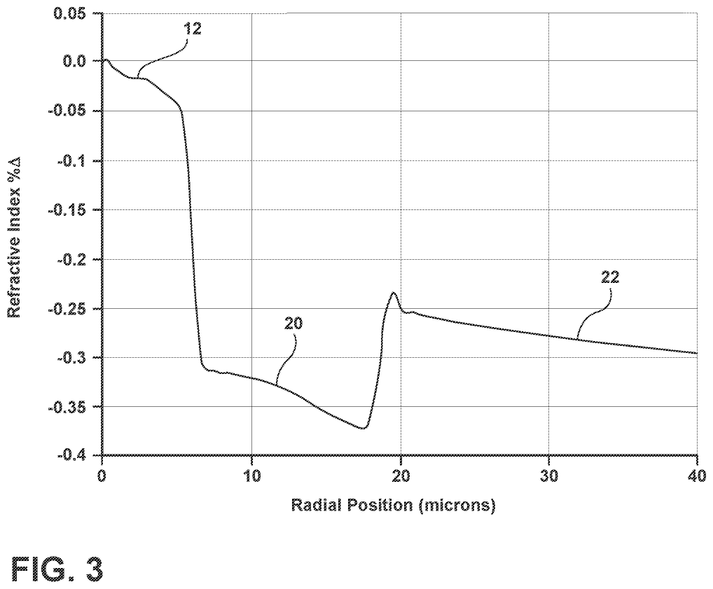

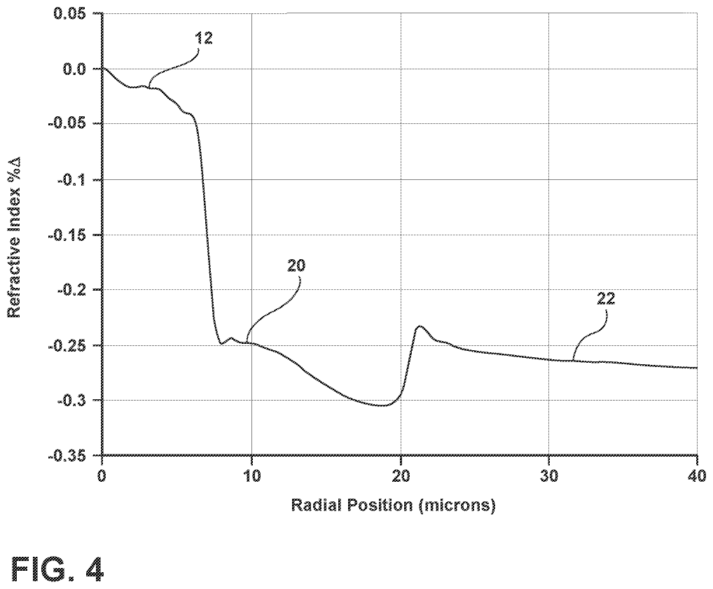

With reference now to FIGS. 2-4, three exemplary relative refractive index profiles of the optical fiber 10 with the core region 12 containing the first alkali dopant and the second alkali dopant are illustrated. The three exemplary embodiments each exhibit similar attenuation at 1550 nm with varying effective areas. Referring initially to FIG. 2, a refractive index profile of a first exemplary embodiment of the optical fiber 10 is illustrated. The optical fiber 10 includes a trench with a depressed refractive index directly adjacent to the core region 12 (e.g. an inner cladding region 20). The optical fiber 10 in FIG. 2 exhibits optical properties that have a cable cutoff wavelength of less than 1530 nm, attenuation at a wavelength of 1550 nm of less than 0.16 dB/km, and an effective area at a wavelength of 1550 nm of 80 μm². FIG. 3 is a refractive index profile of a second exemplary embodiment of the optical fiber 10. The optical fiber 10 includes a trench with a depressed refractive index directly adjacent to the core region 12 (e.g. an inner cladding region 20). The optical fiber 10 in FIG. 3 exhibits optical properties that have a cable cutoff wavelength of less than 1530 nm, attenuation at a wavelength of 1550 nm of less than 0.16 dB/km, and an effective area at a wavelength of 1550 nm of 113 μm². FIG. 4 is a refractive index profile of a third exemplary embodiment of the optical fiber 10. The optical fiber 10 includes a trench with a depressed refractive index directly adjacent to the core region 12 (e.g. in an inner cladding region 20). The optical fiber 10 in FIG. 4 exhibits optical properties that have a cable cutoff wavelength of less than 1530 nm, attenuation at a wavelength of 1550 nm of less than 0.16 dB/km, and an effective area at a wavelength of 1550 nm of 153 μm².

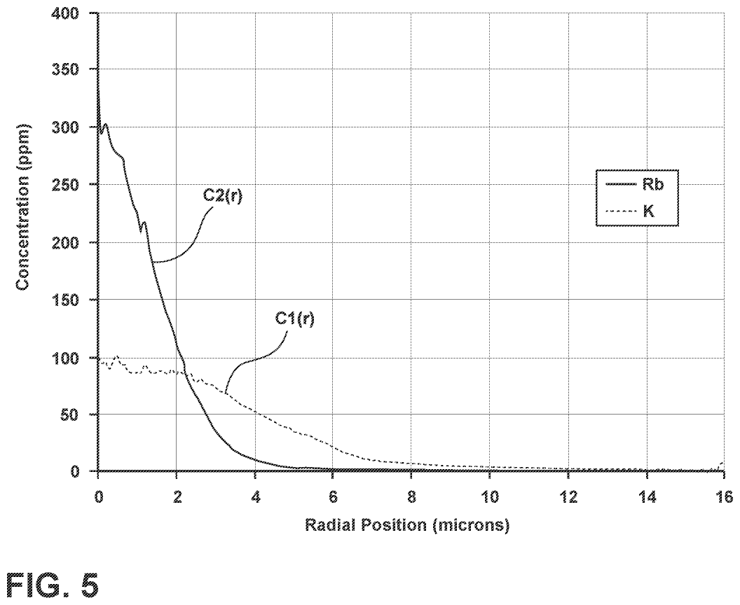

One exemplary embodiment of the radial concentration profiles C1(r) of the first alkali dopant and C2(r) of the second alkali dopant of the optical fiber 10 is illustrated in FIG. 5. The optical fiber 10 includes a silica-based core region 12 doped with two alkali dopants, where r_{core} is half of the mode field diameter at 1550 nm (about 7 μm in the embodiment of FIG. 5). The first alkali dopant comprises potassium oxide (higher diffusivity alkali dopant), and the second alkali dopant comprises rubidium oxide (lower diffusivity alkali dopant). The first alkali dopant and the second alkali dopant each have a combined average core concentration between about 20 ppm<C1+C2<500 ppm. It should be appreciated that small amounts of the first alkali dopant and/or the second alkali dopant may be present in the cladding region 14 (r>half of the mode field diameter at 1550 nm (about 7 μm in the embodiment of FIG. 5)). To the extent that the first alkali dopant and/or the second alkali dopant is present in the cladding region 14, it should further be appreciated that the first alkali dopant is present in a greater concentration in the outer cladding region 14 than the second alkali dopant.

In the illustrated example shown in FIG. 5, measurements of the radial concentration profiles C1(r) and C2(r) of the first and second alkali dopants were conducted with Time-of-Flight Secondary Ion Mass Spectrometry (“ToF-SIMS”) and used with Eqs. (6) and (7) to compute the average concentrations C1 and C2 of the first and second alkali dopants. The average core concentration C1 of the first alkali dopant is about 50 ppm (potassium oxide) and the second core concentration C2 of the second alkali dopant is about 30 ppm (rubidium oxide), with the ratio of average core concentration C2/C1 of about 0.6. The second alkali dopant has a lower diffusivity D2 and the first alkali dopant has a higher diffusivity D1. The average core concentration C1 of the first alkali dopant is greater than or equal to the average core concentration C2 of the second alkali dopant. The radial concentration profile C1(r) of the first alkali dopant and the radial concentration profile C2(r) of the second alkali dopant may both include peak concentrations near the center 16 of the core region 12. However, the radial concentration profile C1(r) of the first alkali dopant decreases at a slower rate with increasing radial coordinate than the radial concentration profile C2(r) of the second alkali dopant. More particularly, the radial concentration profile C2(r) of the second alkali dopant may be greater than the radial concentration profile C1(r) of the first alkali dopant from the center 16 of the core region 12 until a radial coordinate of about 2 μm. The rate R2 of decrease with respect to the radial coordinate of the radial concentration profile C2(r) from the center 16 may be greater than the rate R1 of decrease with respect to the radial coordinate of the radial concentration profile C1(r) by a factor of about 2, about 3, about 1.5 or greater, about 5 or less, or between about 2 and about 5. The greater rate R2 of decrease of the radial concentration profile C2(r) of the second alkali dopant illustrates preferential localization of the second alkali dopant within the central regions of the core region 12 (e.g. near the center 16 and away from the outer radius r_{core}). In some embodiments, the first alkali dopant has a first peak in the radial concentration profile C1(r) and the second alkali dopant has a second peak in the radial concentration profile C2(r) that is greater than the first peak. In some embodiments, the ratio between the peak in the radial concentration profile C1(r) and the peak in the radial concentration profile C2(r) is between about 0.2 and about 0.8, for example, about 0.8 or less, about 0.7 or less, about 0.6 or less, about 0.5 or less, about 0.4 or less, about 0.3 or less, about 0.2 or less, about 0.2 or greater, about 0.3 or greater, about 0.4 or greater, or about 0.5 or greater. In the illustrated embodiment of FIG. 5, the peak in the radial concentration profile C1(r) of the first alkali dopant is about 100 ppm and the peak in the radial concentration profile C2(r) of the second alkali dopant is about 350 ppm. As previously described, the radial concentration profile C2(r) of the second alkali dopant may decrease at the rate R2, which is faster than the rate of decrease R1 of the radial concentration profile of the first alkali dopant. As such, a majority of the second alkali dopant may be confined within the central regions of the core region 12, for example, within about 2 μm from center 16, while the first alkali dopant may extend further away from center 16 in a radial direction.

In some embodiments, the radial concentration profile C2(r) of the second alkali dopant may be greater than the radial concentration C1(r) of the first alkali dopant from the center 16 of the core region 12 until a radial coordinate of about 1 micron or more. For example, the radial concentration profile C2(r) of the second alkali dopant may be greater than the radial concentration profile C1(r) of the first alkali dopant from the center 16 until a radial coordinate between about 1 and about 4 μm, or until a radial coordinate between about 1 and about 3 μm, or until a radial coordinate between about 2 and about 3 μm, or until a radial coordinate of about 2 μm or greater, or until a radial coordinate of about 3 μm or greater, or until a radial coordinate of about 4 μm or greater, or until a radial coordinate of about 5 μm or greater, or until a radial coordinate of about 6 μm or greater, or until a radial coordinate of about 6 μm or less, or until a radial coordinate of about 5 μm or less, or until a radial coordinate of about 4 μm or less, or until a radial coordinate of about 3 μm or less, or until a radial coordinate of about 2 μm or less. The radial concentration profile C1(r) of the first alkali dopant and the radial concentration profile C2(r) of the second alkali dopant can be controlled based on which dopant is selected and the conditions of doping and deposition as will be described in greater detail below.

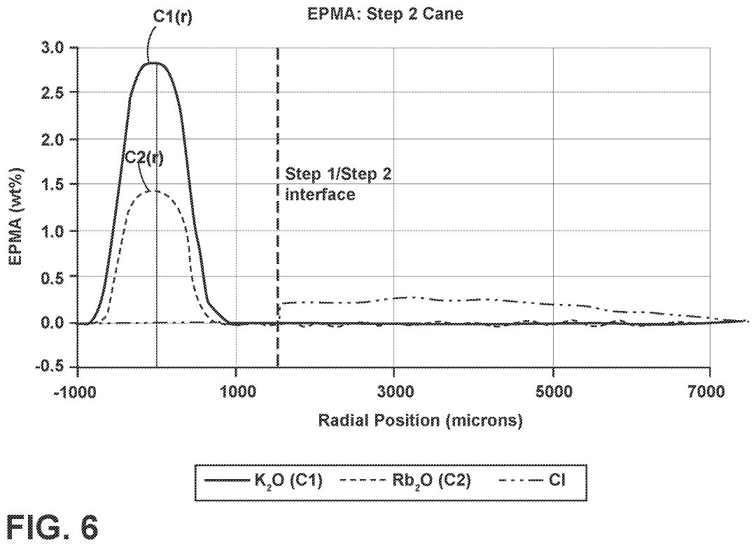

FIG. 6 illustrates a radial profile of the potassium oxide and rubidium oxide concentrations represented in wt % in a corresponding preform cane as analyzed by electron probe microanalysis (“EPMA”). The preform depicted in FIG. 6 was drawn into the optical fiber 10 illustrated in FIG. 5. As illustrated, the core region 12 in the preform includes an inner core segment and an outer core segment forming a core-clad interface (referred to as “Step 1/Step 2 interface” and designated in FIG. 6 with a dashed vertical line). The outer core segment is doped with chlorine, with a peak chlorine concentration near the core segment interface. As illustrated, the radial concentration profile C1(r) of the first alkali dopant (potassium oxide) is greater than the radial concentration profile C2(r) of the second alkali dopant (rubidium oxide) and the radial concentration profile C1(r) of the first alkali dopant has a similar shape to the radial concentration profile C2(r) of the second alkali dopant with a higher peak concentration. More particularly, the peak concentration of the radial concentration profile C1(r) of the first alkali dopant and the peak concentration of the radial concentration profile C2(r) of the second alkali dopant are each at a center of the core region of the preform prior to a drawing process. In some embodiments, the core region of the preform has a radius of about 8000 μm and the first and second alkali dopants are located in the inner core segment. As illustrated, the cladding region in the preform is doped with chlorine, with a peak near the core-clad interface of the preform (referred to as “Step 1/Step 2 interface” and designated in FIG. 6 with a dashed vertical line). In the preform, the first alkali dopant (potassium oxide) has a peak concentration of about 2.8 wt % and the second alkali dopant (rubidium oxide) has a peak concentration of about 1.4 wt %.

The radial concentration profile C1(r) of the first alkali dopant and the radial concentration profile C2(r) of the second alkali dopant are advantageously controlled during the draw process. It has been found that by varying draw conditions in a prescribed manner, alkali metal oxide dopants may be distributed throughout the preform in desired radial concentration profiles. Preferably, the radial concentration profile C1(r) of the first alkali dopant and the radial concentration C2(r) of the second alkali dopant decrease with radius from a peak concentration near the center of the preform toward the outer core radius of the preform. Because the diffusion of alkali metal oxide dopants in general is partially dependent upon the temperature of the glass being doped, and the time the glass remains at the temperature, these same factors play a significant role in controlling the alkali metal oxide diffusion during the process of drawing optical fiber 10 from the preform. The time and the temperature to which an optical fiber preform are exposed during the draw process are controlled by varying the draw speed, the draw (furnace) temperature, and optical fiber tension. For example, increasing the draw speed decreases the dwell time for a particular section of the preform in the draw furnace, thus decreasing the distance which an alkali metal oxide dopant will diffuse across the preform, and hence decrease the radial extent of the alkali metal oxide dopant in the optical fiber 10 drawn from the section of the preform. This may result in less alkali metal oxide diffusing into the cladding region 14 of the optical fiber 10 and, therefore, a higher alkali metal oxide concentration in the core region 12 of the optical fiber 10 or over a limited radial distance in close proximity to the center 16. Conversely, decreasing the draw speed increases the dwell time of the section of the preform from which optical fiber 10 is drawn in the draw furnace, and, therefore, may result in a decrease in the concentration of alkali metal oxide in the core region 12 or near the center 16 of the optical fiber 10 as the alkali metal oxide diffuses further into or in the direction of the cladding region 14 of the optical fiber 10. In a like manner, increasing the furnace temperature may increase the diffusion rate of the alkali metal oxide in the preform, leading to a decrease in the concentration of alkali metal oxide in the core region 12 or near the center 16 of the optical fiber 10. Consequently, draw speed and furnace temperature may be effectively used to control the diffusion, and thus the radial distribution of the first alkali dopant and the second alkali dopant within the resulting optical fiber 10. Variation of draw conditions permits modification not only to the average core concentration C1 of the first alkali dopant and the average core concentration C2 of the second alkali dopant, but also to the radial concentration profile C1(r) of the first alkali dopant and the radial concentration profile C2(r) of the second alkali dopant across a diameter of an optical fiber 10.

As may be appreciated by those skilled in the art, the ability to control the relative amount of alkali metal oxide in the preform during manufacture of the preform, and subsequent forming of the optical fiber 10 by drawing from the preform, is important to the ultimate alkali metal oxide concentration in the optical fiber 10, and therefore the propagation characteristics of optical signals in the optical fiber 10. In some embodiments, control of the distribution of alkali metal oxide dopant in a preform may be accomplished by limiting the heat exposure to the preform during the drawing process. For example, the diffusion profile may be formed in the draw root and a slow cooling device. In some cases, it is desirable to retain the alkali metal oxide (e.g. the first and/or second alkali dopants) in the core region 12 of the optical fiber 10 and limit the diffusion of the alkali metal oxide into the cladding region 14. This may be achieved in some embodiments by forming a substantially chlorine-free optical fiber core region 12 preform surrounded by a cladding region that includes at least an annular section comprising F-doped silica glass, and heat treating the preform before drawing the optical fiber 10 from the preform in the slow cooling device. For example, K₂O has been found to diffuse approximately 10 times to 100 times faster in consolidated F-doped silica glass than in pure silica glass when heat treated within a temperature range from about 1000° C. to about 1600° C. Thus, heat treating the core region of a preform having a cladding region comprising F-doped silica glass may advantageously result in a rapid diffusion of K₂O throughout the cladding region, but at a very low concentration relative to the concentration of alkali metal oxide remaining in the core region 12 of the optical fiber 10 preform. Accordingly, low scattering in the core region 12 of the optical fiber 10 drawn from the preform may be achieved while avoiding the high scattering that may accompany concentrations of both F and K₂O which are similar in magnitude and co-located within the same region of the optical fiber 10. Preferably, the preform is heat treated for at least 6 hours at a temperature of at least about 1000° C. For example, the preform may be heat treated at a temperature of at least about 1400° C., or at a temperature of at least about 1600° C. The preform may be heat treated for at least 30 hours. Preferably, the cladding region 14 of the optical fiber 10 preform comprises silica glass doped with F. After heat treating, the preform may be drawn into the optical fiber 10 by conventional drawing techniques, such as passage through a slow cooling device to form the diffusion profile. In some embodiments, the first alkali dopant and the second alkali dopant are premixed in a single vat prior to forming the preform. In other embodiments, the first alkali dopant and the second alkali dopant are mixed in separate vats prior to forming the preform.

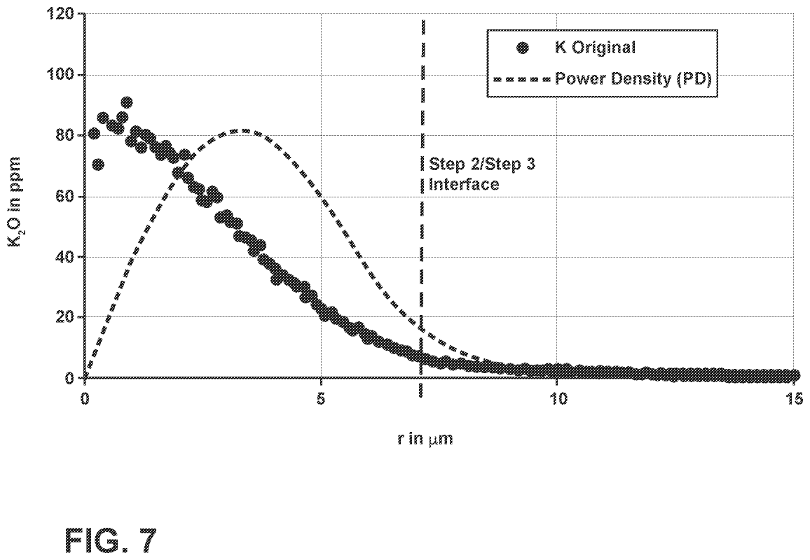

FIG. 7 illustrates a comparative example wherein the nominal refractive index profile and optical properties are similar to the illustrated example in FIG. 5. The comparative optical fiber includes a core region doped with a single alkali dopant (potassium oxide). The comparative example graphically illustrates the radial concentration profile of potassium oxide in ppm along with a power density profile for the comparative optical fiber.

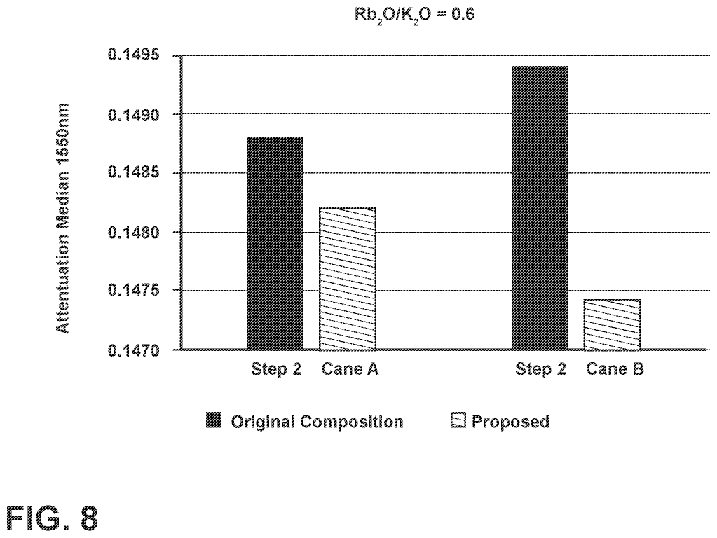

FIG. 8 illustrates the attenuation performance of the optical fiber 10 containing a first alkali dopant (potassium oxide) and a second alkali dopant (rubidium oxide) at a concentration ratio Rb₂O/K₂O of about 0.6 and a comparative example of an optical fiber drawn under identical draw conditions with a single alkali (potassium oxide) as illustrated in FIG. 7. The optical fibers were drawn from different canes drawn from a common preform. Each unit along the horizontal axis designates a different cane and the attenuation (vertical axis) of fibers drawn from each cane is marked by the data points. Optical fibers drawn from each cane were stored on a series of reels. The attenuation performance depicted in FIG. 8 was determined by averaging over various numbers of reels and various distances along the length of the optical fiber for each reel. Attenuation is reported as median attenuation (in units of dB/km) at a wavelength of 1550 nm. The median attenuation of the optical fibers with the first and second alkali dopants (marked “proposed”) were significantly lower than the comparative fiber with a single alkali dopant.

According to one aspect of the disclosure, an optical fiber is provided. The optical fiber comprises a core region comprising silica glass doped with a first alkali dopant and a second alkali dopant. The first alkali dopant has a first average core concentration of C1 and a first diffusivity D1. The second alkali dopant has a second average core concentration of C2 and a second diffusivity D2. The second diffusivity D2 is less than the first diffusivity D1. A cladding region surrounds the core region. The average core concentrations C1, C2 of the first and second alkali dopants satisfy a relation 0.1≤C2/C1≤1.

According to another aspect, the first alkali dopant comprises potassium oxide.

According to a related aspect, the second alkali dopant comprises rubidium oxide.

According to another aspect, the first alkali dopant comprises sodium oxide.

According to a related aspect, the second alkali dopant comprises potassium oxide.

According to another aspect, the first average core concentration C1 is greater than the second average core concentration C2.

According to a related aspect, the first average core concentration C1 and the second average core concentration C2 further satisfy a relation C2/C1 equal to about 0.6.

According to another aspect, the average core concentration of the first alkali dopant in the core region is in a range of 10 ppm<C1<400 ppm.

According to another aspect, the average core concentration of the second alkali dopant in the core region is in a range of 5 ppm<C2<400 ppm.

According to another aspect, an effective area of the optical fiber is between 60 μm² and 100 μm² at a wavelength of 1550 nm.

According to another aspect, an effective area of the optical fiber is between 100 μm² and 160 μm² at a wavelength of 1550 nm.

According to another aspect, the optical fiber is configured to have a transmission loss of less than 0.17 dB/km at a wavelength of 1550 nm.

According to a related aspect, the transmission loss is less than 0.16 dB/km at a wavelength of 1550 nm.

According to another related aspect, the transmission loss is less than 0.15 dB/km at a wavelength of 1550 nm.

According to another aspect, the optical fiber is configured to have a Rayleigh scattering loss α′ of less than 0.13 dB/km at a wavelength of 1550 nm.

According to a related aspect, the Rayleigh scattering loss α′ is less than 0.126 dB/km at a wavelength of 1550 nm.

According to another aspect, the optical fiber is configured to have a small angle scattering loss of less than 0.004 dB/km at a wavelength of 1550 nm.

According to another aspect, the small angle scattering loss is less than 0.003 dB/km at a wavelength of 1550 nm.

According to another aspect, the average core concentrations C1, C2 further satisfy the relation 20 ppm<C1+C2<500 ppm.

According to another aspect, the core region comprises silica glass doped only with the first alkali dopant and the second alkali dopant.

Many variations and modifications may be made to the above-described embodiments of the disclosure without departing substantially from the spirit and various principles of the disclosure. All such modifications and variations are intended to be included herein within the scope of this disclosure and protected by the following claims. It will be understood that any described processes or steps within described processes may be combined with other disclosed processes or steps to form structures within the scope of the present disclosure. The exemplary structures and processes disclosed herein are for illustrative purposes and are not to be construed as limiting.

To the extent not already described, the different features of the various aspects of the present disclosure may be used in combination with each other as desired. That a particular feature is not explicitly illustrated or described with respect to each aspect of the present disclosure is not meant to be construed that it cannot be, but it is done for the sake of brevity and conciseness of the description. Thus, the various features of the different aspects may be mixed and matched as desired to form new aspects, whether or not the new aspects are expressly disclosed.

What is claimed is:

1. An optical fiber comprising:
a core region comprising silica glass doped with a first alkali dopant and a second alkali dopant, the first alkali dopant having a first average core concentration C1 and a first diffusivity D1, the second alkali dopant having a second average core concentration C2 and a second diffusivity D2, the second diffusivity D2 less than the first diffusivity D1; and
a cladding region surrounding the core region;
wherein the first average core concentration C1 and the second average core concentration C2 satisfy a relation 0.10≤C2/C1≤1.00.

2. The optical fiber of claim 1, wherein the first alkali dopant comprises potassium oxide.

3. The optical fiber of claim 2, wherein the second alkali dopant comprises rubidium oxide.

4. The optical fiber of claim 1, wherein the first alkali dopant comprises sodium oxide.

5. The optical fiber of claim 4, wherein the second alkali dopant comprises potassium oxide.

6. The optical fiber of claim 1, wherein the first average core concentration C1 the second average core concentration C2 satisfy a relation 0.20≤C2/C1≤0.90.

7. The optical fiber of claim 1, wherein the first average core concentration C1 and the second average core concentration C2 satisfy a relation 0.40≤C2/C1≤0.70.

8. The optical fiber of claim 1, wherein the average core concentration of the first alkali dopant in the core region is in a range of 10 ppm<C1<400 ppm.

9. The optical fiber of claim 1, wherein the average core concentration of the second alkali dopant in the core region is in a range of 5 ppm<C2<400 ppm.

10. The optical fiber of claim 1, wherein an effective area of the optical fiber is between 60 μm² and 100 μm² at a wavelength of 1550 nm.

11. The optical fiber of claim 1, wherein an effective area of the optical fiber is between 100 μm² and 160 μm² at a wavelength of 1550 nm.

12. The optical fiber of claim 1, wherein the optical fiber is configured to have a transmission loss of less than 0.17 dB/km at a wavelength of 1550 nm.

13. The optical fiber of claim 12, wherein the transmission loss at a wavelength of 1550 nm is less than 0.16 dB/km.

14. The optical fiber of claim 13, wherein the transmission loss at a wavelength of 1550 nm is less than 0.15 dB/km.

15. The optical fiber of claim 1, wherein the optical fiber is configured to have a Rayleigh scattering loss α′ of less than 0.13 dB/km at a wavelength of 1550 nm.

16. The optical fiber of claim 15, wherein the Rayleigh scattering loss α′ is less than 0.126 dB/km at a wavelength of 1550 nm.

17. The optical fiber of claim 1, wherein the optical fiber is configured to have a small angle scattering loss of less than 0.004 dB/km at a wavelength of 1550 nm.

18. The optical fiber of claim 17, wherein the small angle scattering loss is less than 0.003 dB/km at a wavelength of 1550 nm.

19. The optical fiber of claim 1, wherein the first average core concentration C1 and the second average core concentration C2 further satisfy the relation 20 ppm<C1+C2<500 ppm.

20. The optical fiber of claim 1, wherein the core region comprises silica glass doped only with the first alkali dopant and the second alkali dopant.
